(19) United States
(12) Patent Application Publication
(10) Pub. No.: US 2023/0090254 A1
(43) Pub. Date: Mar. 23, 2023

(54) TRANSPORTING MATTRESSES

(71) Applicant: Purple Innovation, LLC, Lehi, UT (US)

(72) Inventors: Brock Keith Harris, Draper, UT (US); Wade Hoover, Lehi, UT (US); Lidia Saldaña, West Valley City, UT (US)

(21) Appl. No.: 17/479,868

(22) Filed: Sep. 20, 2021

(51) Int. Cl. B65G 7/12; A45F 3/14

(52) U.S. Cl. CPC B65G 7/12; A45F 3/14; A45F 2003/142

(57) ABSTRACT

An apparatus for transporting a mattress, or a mattress transporter, includes a flat element and a plurality of straps extending across the flat member. Handles may be positioned along or defined by each strap. The flat member and straps are arranged and configured to be positioned around the mattress to facilitate its movement from one location to another. The mattress transporter may be used to fold the mattress or it may leave the mattress in an unfolded arrangement. As the mattress transporter is positioned around the mattress, one or more handles along or defined by each strap may be positioned on each side of the mattress. The mattress transporter, when assembled with a mattress, may define a transportable mattress. Methods for transporting mattresses are also disclosed.

### TECHNICAL FIELD

This disclosure relates generally to apparatuses and methods for transporting mattresses and, more specifically, to apparatuses and methods that fold mattresses and secure them in a folded arrangement to facilitate their transportation.

### RELATED ART

Mattresses occasionally need to be moved to provide access to the floor beneath an individual's bed, to rearrange a bedroom, or to move the mattress from one location to another (e.g., within the same dwelling, from one dwelling to another, etc.). Large mattresses are typically difficult for two or more people to move because of their size and often because of their weight. Mattresses that include gel components are notoriously heavy.

### SUMMARY

An apparatus that facilitates the transportation of mattresses, including large mattresses and smaller mattresses, is referred to herein as a “mattress transporter.” The phrase “large mattress,” as used herein, refers to mattresses having widths of about 150 cm (about 5 feet) and larger and lengths of about 200 cm (about 6 feet, 6 inches) and larger. The phrase “smaller mattress,” as used herein, refers to mattresses having widths of about 140 cm (about 4 feet, 7 inches) and less and lengths of about 200 cm (about 6 feet, 6 inches) and smaller.

A mattress transporter according to this disclosure may include a flat element and a plurality of straps. The flat element may comprise a pliable material. The material of the mattress transporter may slide easily beneath the mattress and its support (e.g., a bed platform, a box spring, a floor, etc.). In some embodiments, the flat element may comprise a fabric (e.g., a non-stretch nylon, etc.), a plastic film, or the like.

The flat element may have a length and a width. Along the length and across the width, the flat element may have a first end, a center, and a second end. A first portion of the flat element is located between the first end and the center. A second portion of the flat element is located between the second end and the center. The first portion and the second portion may meet at the center of the flat element. The flat element may also include a first side extending along the length, on a first boundary of the width of the flat element, and a second side extending along the length, on a second boundary of the width of the flat element.

The flat element may fold along is center. Thus, the first portion and the second portion may be superimposed with each other.

The flat element may have a configuration, or a shape and dimensions, designed to fold a large mattress in half along a centerline of the mattress. In some embodiments, the configuration of the flat element may facilitate folding of the mattress along a centerline between sides of the mattress, or the longitudinal centerline of the mattress, which extends along a length of the mattress. The center of such a flat element may, therefore, be located to be positioned along the longitudinal centerline of the mattress. In other embodiments, the flat element may have a configuration designed to fold a mattress in half along a centerline between ends of the mattress (e.g., a head end, a foot end, etc.), or the latitudinal centerline of the mattress, which extends across a width of the mattress. The center of such a flat element may, therefore, be located to be positioned along the latitudinal centerline of the mattress. In still other embodiments, a configuration of the flat element may enable it to be used to fold a mattress along its longitudinal centerline or its latitudinal centerline.

A configuration of the flat element may also enable it to be used to transport smaller mattresses without folding them. When used in such a way, the center of such a flat element may be positioned along a side edge of the small mattress.

The straps may extend across the width of the flat element. In some embodiments, the straps may be secured (e.g., sewn, welded, adhesively bonded, etc.) to the flat element. A strap may be positioned (e.g., midway, about midway, etc.) between the first end and the center of the flat element. Another strap may be positioned (e.g., midway, about midway, etc.) between the second end and the center of the flat element. The straps may facilitate folding of a mattress, as well as secure the mattress in a folded arrangement. The straps may be positioned close enough to each other to enable an individual to simultaneously grasp the adjacent straps. Locations of the straps may prevent portions of a mattress located between the straps from bulging and, thus, from unfolding while the straps secure the mattress in the folded arrangement.

A length of each strap may equal or exceed, in combination, a width or a length of the mattress with which the mattress transporter is to be used and two times a thickness of the mattress. Such a length may ensure that the strap is long enough to extend completely around a folded mattress.

Each strap may include a first end and a second end. The first end may extend beyond the first end of the flat element. The second end may extend beyond the second side of the flat element. As the first end and second end of each strap are pulled together, the straps may fold the flat element. The first end and second end of each strap may be secured together (e.g., by tying them together, by way of a buckle, etc.). As the first end and second end of each strap are secured to each other, the strap may form a loop. Each strap may be cinched and loosened (e.g., by way of a buckle, etc.) to adjust a size of a loop formed by the strap as its first end and second end are secured together.

Handles may be provided along each strap such that at least one first handle on each strap is located over the first portion of the flat element and at least one second handle on each strap is located over the second portion of the flat element. The handles may be defined between adjacent but spaced apart locations where each strap is secured (e.g., sewn, etc.) to the flat element. In some embodiments, including those where a strap is secured to the flat element at a series of spaced apart locations, a series of handles may be defined over the first portion and/or the second portion of the flat element. In a specific embodiment, a continuous series of handles may extend along an entirety of the first portion and over at least a portion of the second portion of the flat element. The locations at which the handles are provided may facilitate lifting of a mattress by individuals of a variety of different body types (e.g., heights, arm lengths, etc.). The locations at which the handles are provided may also enable a mattress to be easily lifted a plurality of different heights.

In another aspect, methods for transporting mattresses are disclosed. Such a method may include preparing the mattress for transport. Preparing the mattress for transport may comprise sliding a flat element and straps of a mattress transporter beneath a bottom surface of the mattress. First ends of the straps may extend beyond a first edge of the mattress; second ends of the straps may extend beyond a second edge of the mattress. In some embodiments, first ends of the straps may extend beyond a first side of the mattress, while second ends of the straps may extend beyond a second side of the mattress. In other embodiments, first ends of the straps may extend beyond a first end (e.g., a head end, a foot end) of the mattress, while second ends of the straps may extend beyond a second end (e.g., a foot end, a head end) of the mattress. At least a portion of the flat element may be located beneath the mattress. In some embodiments, including those where the mattress transporter is used with a large mattress, the entire flat element may be located beneath the mattress. In other embodiments, including those where the mattress transporter is used with a smaller mattress, a portion of the flat element may be located beneath the mattress, while another portion of the flat element may extend beyond the mattress (e.g., beyond a side of the mattress, etc.).

With the flat element and straps in place, the first end and second end of each strap may be pulled together over a top surface of the mattress (i.e., the first end of each strap may be pulled toward the second end of that strap, the second end of each strap may be pulled toward the first end of that strap, both ends of the each strap may be pulled toward each other.

In some embodiments of preparing a mattress (e.g., a large mattress, etc.) for transport, as the first end and second end of each strap are pulled together, the mattress may fold and, thus, place the mattress in a folded arrangement. In embodiments where the first ends and second ends of the straps extended respectively beyond the first side and second side of the mattress, the mattress may fold along the longitudinal centerline of the mattress. In embodiments where the first ends and second ends of the straps extended respectively beyond the first side and second side of the mattress, the mattress may fold along the latitudinal centerline of the mattress.

The first end and second end of each strap may be secured together to hold, or secure, the mattress in the folded arrangement. The first end and second each of each strap may be secured together in any suitable manner. For example, the first end and second end of each strap may be secured together with a buckle (e.g., a single buckle, a buckle with mating parts, etc.). As another option, the first end and second end of each strap may be simply tied together.

In other embodiments of preparing a mattress (e.g., a smaller mattress, etc.) for transport, a first portion of the flat element of the mattress transporter may extend beyond the mattress, the first portion of the flat element and corresponding portions of the straps may be positioned over a top surface of the mattress, and the first end of each strap may be secured to the second end of the same strap.

Once the first end and second end of a strap are secured together, the strap may be cinched, or tightened. Cinching each strap may further compress a folded mattress into the folded arrangement and may secure the mattress transporter in place on any size of mattress, whether the mattress is folded or unfolded.

Assembly of the mattress transporter with a mattress (e.g., a large mattress, a smaller mattress, etc.) may provide a transportable mattress arrangement. In such an arrangement, the mattress may be folded (e.g., along a longitudinal centerline, along a latitudinal centerline, etc.) or unfolded.

With the mattress prepared for transport, it may be transported. Transporting the mattress may include grasping the straps, lifting the mattress, and transporting the mattress from one location to another.

Grasping the straps may include grasping a handle on the strap. In embodiments where a mattress transporter that includes a plurality of handles along each strap has been secured to the mattress, an individual may choose the handle(s) he or she will grasp has he or she lifts and moves the mattress.

Other aspects of this disclosure, as well as features and advantages of various aspects of the disclosure, should become apparent to those of ordinary skill in the art through consideration of the ensuing description, the accompanying drawings, and the appended claims.

### BRIEF DESCRIPTION OF THE DRAWINGS

In the drawings:

FIG. 1 is a plan view of an embodiment of a mattress transporter according to this disclosure;

FIG. 2 is a side view of the embodiment of the mattress transporter shown in FIG. 1;

FIG. 3 is a plan view of another embodiment of a mattress transporter according to this disclosure;

FIG. 4 is a schematic representation showing the embodiment of mattress transporter shown in FIG. 1 beneath a bottom surface of a mattress and oriented along a length of the mattress;

FIG. 5 is a plan view of a mattress that has been prepared for transport using the embodiment of the mattress transporter shown in FIGS. 1 and 2 in the orientation depicted by FIG. 4 to fold the mattress along its length to provide an embodiment of a transportable mattress;

FIG. 6 is a perspective view of the mattress and mattress transporter shown in the assembled arrangement depicted by FIG. 5;

FIG. 7 is a schematic representation showing the embodiment of mattress transporter shown in FIG. 1 beneath a bottom surface of a mattress and oriented across a width of the mattress;

FIG. 8 is a plan view of a mattress that has been prepared for transport using the embodiment of the mattress transporter shown in FIGS. 1 and 2 in the orientation depicted by FIG. 7 to fold the mattress across its width to provide another embodiment of transportable mattress;

FIG. 9 is a perspective view of the mattress and mattress transporter shown in the assembled arrangement depicted by FIG. 8;

FIG. 10 is a schematic representation showing the embodiment of mattress transporter shown in FIG. 1 beneath a bottom surface of a smaller mattress and oriented to be secured to the mattress without folding the mattress;

FIG. 11 is a plan view of a mattress that has been prepared for transport using the embodiment of the mattress transporter shown in FIGS. 1 and 2 in the orientation depicted by FIG. 10 without folding the mattress to provide yet another embodiment of transportable mattress; and

FIG. 12 is a perspective view of the mattress and mattress transporter shown in the assembled arrangement depicted by FIG. 11.

### DETAILED DESCRIPTION

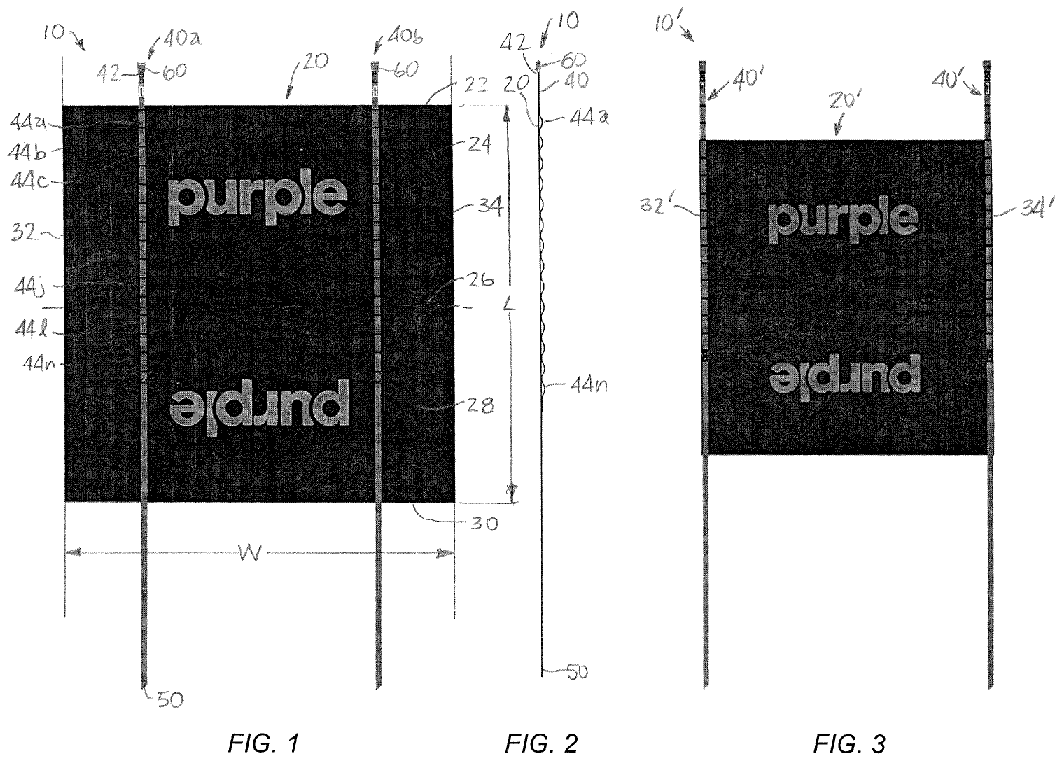

An embodiment of a mattress transporter 10 is illustrated by FIGS. 1 and 2. The mattress transporter includes a flat element 20 and a plurality of straps 40 (individually strap 40a, 40b, etc.).

The flat element 20 may have a length L and a width W. The flat element 20 includes a first end 22, a first portion 24, a center 26, a second portion 28, and a second end 30. The first end 22 may extend across the width W of the flat element 20. The first portion 24 may be located adjacent to the first end 22. The center 26 may also extend across the width W of the flat element 20 on an opposite side of the first portion 24 from the first end 22. The second portion 28 is located on an opposite side of the center 26 from the first portion 24. The second end 30, which may also extend across the width W of the flat element 20, is located on an opposite side of the second portion 28 from the center., and a second end 30.

The flat element 20 also includes a first side 32 and a second side 34 extending along the length L of the flat element 20. The first side 32 and second side 34 respectively define a first boundary and second boundary of the width W of the flat element 20.

The flat element 20 may fold along is center 26, enabling the first portion 24 and the second portion 28 to be superimposed with each other. Thus, in some embodiments, the flat element 20 may comprise a pliable material. The material from which the flat element 20 is formed may facilitate its positioning and movement (e.g., sliding, etc.) between a bottom surface of a mattress and a surface that supports the mattress (e.g., a surface of a bed platform, a surface of a box spring, a floor, etc.). In some embodiments, the material from which the flat element 20 is formed may substantially lack stretch (i.e., it may not stretch more than 5% in any direction) or it may not stretch. Some non-limiting examples of materials that may be used to form the flat element 20 include fabrics (e.g., a nylon, a non-stretch nylon, etc.), plastic films, and the like.

Each strap 40 may comprise an elongated element that may be formed into a loop. Thus, each strap 40 may be flexible or even pliable. In some embodiments, each strap 40 may comprise a nylon strap.

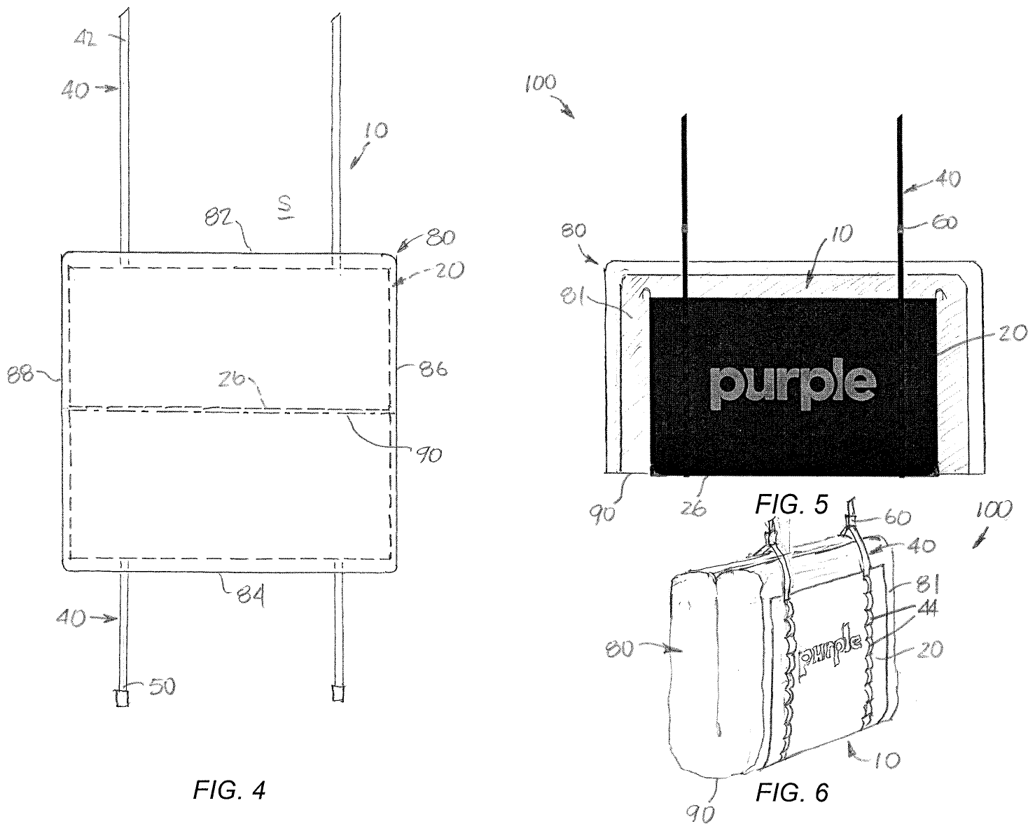

In embodiments where the mattress transporter 10 has a configuration that enables it to facilitate folding of a mattress (FIGS. 4-9), a length of each strap 40 may equal or exceed, in combination, a width or a length of the mattress 80 and two times a thickness of the mattress 80. Such a length may ensure that the strap 40 is long enough to extend completely across a bottom surface 81 (FIGS. 4-9) and opposite sides 82 and 84 or ends 86 and 88 of the mattress 80 and, thus, around a mattress 80 that is to be folded during transport. In embodiments where the mattress transporter 10 has a configuration that enables it to facilitate transportation of mattress 80 without folding the mattress, a length of each strap 40 may equal or exceed, in combination, a distance that completely circumscribes a width or a length of the mattress 80 (i.e., two times a width or a length of the mattress 80 plus two times a thickness of the mattress 80).

Each strap 40 may include a first end 42 and a second end 50. The first end 42 of the strap 40 may extend beyond the first end 22 of the flat element 20. The second end 50 of the strap 40 may extend beyond the second end 30 of the flat element 20. As the first end 42 and second end 50 of each strap 40 are pulled together, the straps 40 may fold the flat element 20.

The first end 42 and second end 50 of each strap 40 may be secured together to define a loop from the strap 40. In the embodiment illustrated by FIGS. 1 and 2, a buckle 60 may be provided adjacent to the first end 42 of each strap 40. In some embodiments, the buckle 60 may facilitate cinching and loosening of the strap 40, or adjustment of the size of a loop defined as the first end 42 and second end 50 of the strap 40 are secured to each other. The buckle 60 may comprise any suitable type of buckle (e.g., a cinch buckle, a cam buckle, a slide buckle, a two-piece snap buckle, etc.).

The straps 40 may extend across the width W of the flat element 20. The straps 40 may be secured (e.g., sewn, welded, adhesively bonded, etc.) to the flat element 20 at one or more locations 46. A strap 40a may be positioned (e.g., midway, about midway, etc.) between the first end 22 and the center 26 of the flat element 20. Another strap 40b may be positioned (e.g., midway, about midway, etc.) between the second end 30 and the center 26 of the flat element 20. Alternatively, as shown in FIG. 3, a mattress transporter 10′ may include straps 40′ positioned along the first side 32′ and second side 34′ of the flat element 20′.

With returned reference to FIGS. 1 and 2, handles 44a, 44b, 44c, etc. (each, a handle 44; collectively, handles 44) may be provided along each strap 40 such that at least one first handle 44b-44j on each strap 40 is located over the first portion 24 of the flat element 20 and at least one second handle 441-44n on each strap 40 is located over the second portion 28 of the flat element 20. The handles 44 may be defined between adjacent but spaced apart locations 46 where each strap 40 is secured (e.g., sewn, etc.) to the flat element 20. In some embodiments, including those where a strap 40 is secured to the flat element 20 at a series of spaced apart locations 46, a series of handles 44 may be defined over the first portion 24 and/or the second portion 28 of the flat element 20. In a specific embodiment, a continuous series of handles 44 may extend along an entirety of the first portion 24 and over at least a portion of the second portion 28 of the flat element 20.

As illustrated by FIGS. 4-9, a configuration (i.e., a shape, dimensions, etc.) of the mattress transporter 10 may enable it to fold a large mattress 80 in half along a centerline 90, 92 of the mattress 80. Without limitation, the mattress 80 may comprise a large mattress, which may have a width of about 150 cm (about 5 feet) or larger and a length of about 200 cm (about 6 feet, 6 inches) or larger, including, but not limited to, mattresses that are referred to as “king,” “California king,” “Texas king,” and “Alaskan king” mattresses. The configuration of mattress transporter 10 shown in FIGS. 4-9 may also be used to transport smaller mattresses, including, without limitation, queen, full, twin XL (extra long), and twin mattresses in a folded configuration. In some embodiments, such as that shown in FIGS. 4-6, the configuration of the mattress transporter 10 may facilitate folding of the mattress 80 along a longitudinal centerline 90 of the mattress, which is located halfway between sides 82 and 84 of the mattress 80 and extends along a length of the mattress 80. As shown in FIG. 4, the mattress transporter 10 may be slid between the bottom surface 81 (FIGS. 5 and 6) of the mattress 80 and a surface S that supports the mattress 80 with the mattress transporter 10 oriented such that the mattress 80 substantially covers the flat element 20, the first ends 42 of the straps 40 extending beyond the first side 82 of the mattress 80, and the second ends 50 of the straps 40 extending beyond the second side 84 of the mattress 80. The center 26 of the flat element 20 of the mattress transporter 10 may be positioned along the longitudinal centerline 90 of the mattress 80. As shown in FIGS. 5 and 6, upon bringing the first end 42 and second end 50 of each strap 40 together and securing them together (e.g., with the buckle 60), the mattress 80 may be folded along its longitudinal centerline 90 and secured in such a folded arrangement. Optionally each strap 40 may be cinched, or tightened, to secure it around the mattress 80 and/or to compress the mattress 80 in its folded arrangement. Together, the mattress 80 and the mattress transporter 10 in the arrangement depicted by FIGS. 5 and 6 define an embodiment of a transportable mattress 100.

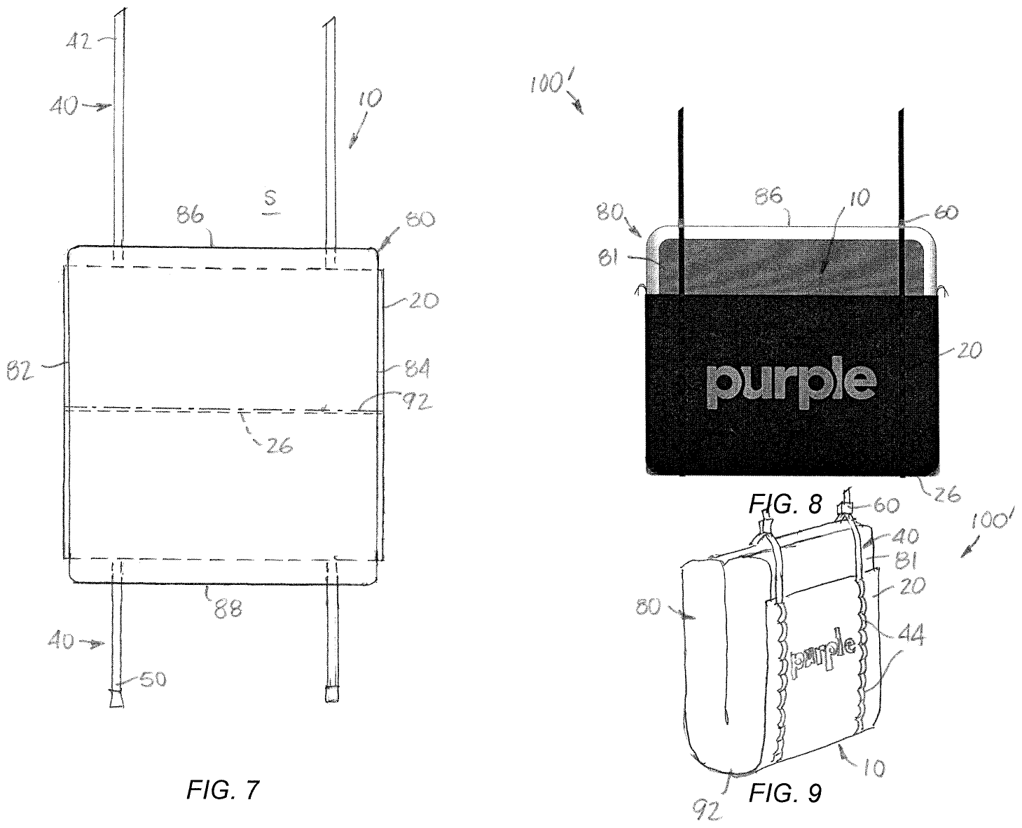

In other embodiments, such as that depicted by FIGS. 7-9, the mattress transporter 10 may have a configuration designed to fold a mattress 80 in half along a latitudinal centerline 92 of the mattress 90, which is located halfway between ends 86 and 88 of the mattress 80 and extends across a width of the mattress 80. As shown in FIG. 7, the mattress transporter 10 may be slid between the bottom surface 81 of the mattress 80 and a surface S that supports the mattress 80 with the mattress transporter 10 oriented with the mattress 80 substantially covering the flat element 20, the first ends 42 of the straps 40 extending beyond the first end 86 of the mattress 80, and the second ends 50 of the straps 40 extending beyond the second end 88 of the mattress 80. The center 26 of the flat element 20 of the mattress transporter 10 may be positioned along the latitudinal centerline 92 of the mattress 80. As shown in FIGS. 8 and 9, upon bringing the first end 42 and second end 50 of each strap 40 together and securing them together (e.g., with the buckle 60), the mattress 80 may be folded along its latitudinal centerline 92 and secured in such a folded arrangement. Optionally each strap 40 may be cinched, or tightened, to secure it around the mattress 80 and/or to compress the mattress 80 in its folded arrangement. Together, the mattress 80 and the mattress transporter 10 in the arrangement depicted by FIGS. 8 and 9 define another embodiment of a transportable mattress 100′.

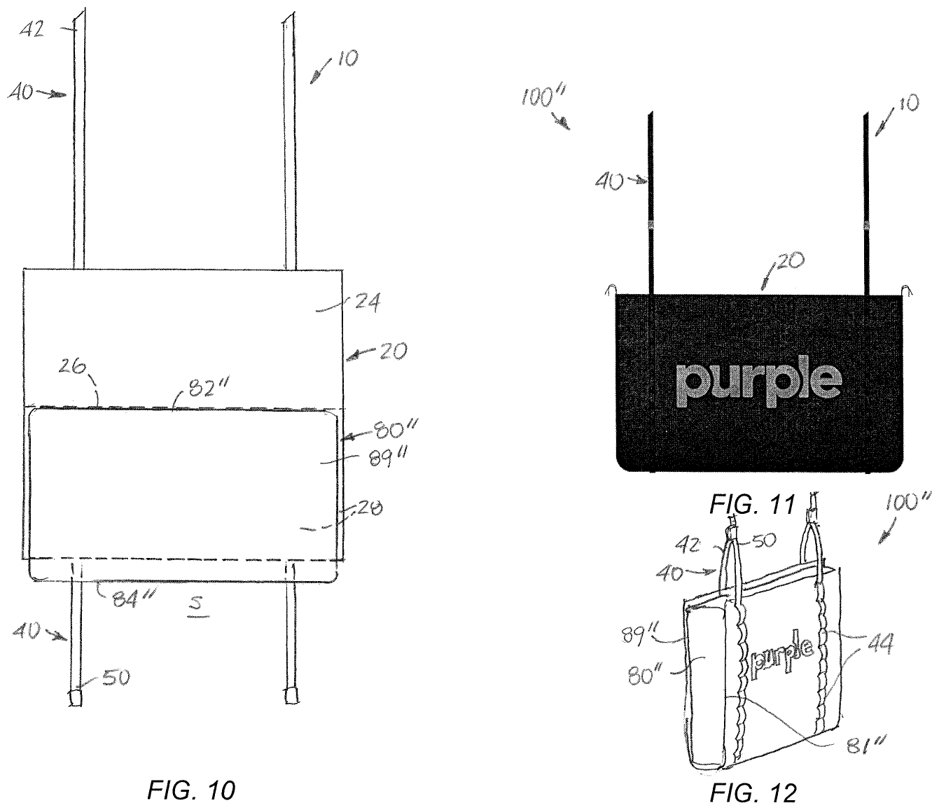

Turning now to FIGS. 10-12, a mattress transporter 10 according to this disclosure may also be used to transport a mattress 80″ without folding the mattress 80″, or with the mattress 80″ in an unfolded arrangement. Without limitation, the mattress 80″ may comprise a smaller mattress, which may have a width of about 140 cm (about 4 feet, 7 inches) or less and a length of about 200 cm (about 6 feet, 7 inches) or less, such as twin or twin XL (extra long) mattress sizes. FIG. 10 depicts positioning of the flat element 20 of the mattress transporter 10 partially beneath a bottom surface 81″ (FIG. 12) of the mattress 80″. More specifically, the second portion 28 of the flat element 20 of the mattress transporter 10 is positioned beneath the bottom surface 81″ of the mattress 80″ while the second ends 50 of the straps 40 extend beyond the second side 84″ of the mattress 80″ and the first portion 24 of the flat element 20 and first ends 42 of the straps 40 extend beyond the first side 82″ of the mattress 80″. The center 26 of the flat element 20 of the mattress transporter 10 may be positioned beneath or adjacent to the first side 82″ of the mattress 80″. As shown in FIGS. 11 and 12, upon pulling the first ends 42 of the straps 40 toward the second ends 50 of the straps 40, the first portion 24 of the flat element 20 of the mattress transporter 10 may be placed over a top surface 89″ of the mattress 80″. The first end 42 of each strap 40 is secured to the second end 50 of each strap 40 (e.g., with the buckle 60). Optionally each strap 40 may be cinched, or tightened, to secure it around the mattress 80″ and/or to compress the mattress 80″ somewhat. Together, the mattress 80″ and the mattress transporter 10 in the arrangement depicted by FIGS. 11 and 12 define yet another embodiment of a transportable mattress 100″.

Referring to FIGS. 6, 9, and 12, once a mattress 80, 80″ has been prepared for transport, it may be moved, or transported. A method of transporting a mattress 80, 80″ includes grasping the straps 40 and lifting the straps 40 to lift the remainder of the mattress transporter 10 and the mattress 80, 80″. Grasping the straps 40 may include grasping a handle 44 on each strap 40. In embodiments where a mattress transporter 10 that includes a plurality of handles 44 along each strap 40 has been secured to the mattress 80, 80″, an individual may choose the handle(s) 44 he or she will grasp has he or she lifts and moves the mattress 80, 80″.

With the mattress 80, 80″ lifted, it may be transported from one location to another.

Although the preceding disclosure provides many specifics, these should not be construed as limiting the scope of any of the claims that follow, but merely as providing illustrations of some embodiments of elements and features of the disclosed subject matter. Other embodiments of the disclosed subject matter, and of their elements and features, may be devised which do not depart from the spirit or scope of any of the claims. Features from different embodiments may be employed in combination. Accordingly, the scope of each claim is limited only by its plain language and the legal equivalents thereto.

What is claimed:

1. A mattress transporter, comprising:
a flat element with a length and a width and including a first portion extending from a first end of the length to a center of the length and a second portion extending from a second end of the length to the center of the length, the first portion and the second portion meeting at a center of the length, the flat element having a folded arrangement in which the first portion and the second portion are at least partially superimposed with each other, the flat element comprising a material that readily slides beneath a mattress; and
a plurality of straps extending along the length of the flat element, beyond each of the first end and the second end, each strap of the plurality of straps including a first end and a second end securable to each other to place the flat element in the folded arrangement, each strap of the plurality of straps secured to the flat element in a manner that defines a series of handles along each of the first portion and the second portion of the flat element.

2. The mattress transporter of claim 1, wherein the material of the flat element comprises a non-stretchable nylon.

3. The mattress transporter of claim 1, wherein each strap defines a continuous series of handles that extends along an entirety of the first portion of the flat element and along at least a portion of the second portion of the flat element.

4. The mattress transporter of claim 3, wherein the continuous series of handles is defined by spaced apart locations along each strap where each strap is sewn to the flat element.

5. The mattress transporter of claim 1, wherein each strap of the plurality of straps has a length that exceeds a combined dimension of a width of the mattress and two times a thickness of the mattress.

6. The mattress transporter of claim 5, wherein the center of the length of the flat element is positionable along a centerline of the mattress.

7. The mattress transporter of claim 6, wherein the center of the length of the flat element is positionable along a centerline between sides of the mattress.

8. The mattress transporter of claim 6, wherein the center of the length of the flat element is positionable along a centerline between ends of the mattress.

9. The mattress transporter of claim 1, wherein the first end and the second end of each strap couple to each other to superimpose the first portion and the second portion of the flat element.

10. The mattress topper of claim 1, further comprising:
a buckle along each strap to couple the first end and the second end of each strap to each other.

11. A method for transporting a mattress, comprising:
sliding a flat element and straps of a mattress transporter beneath the mattress, first ends of the straps extending beyond a first edge of the mattress, second ends of the straps extending beyond a second edge of the mattress, the flat element being located beneath the mattress;
pulling the second ends of the straps toward the first ends of the straps, the straps and the flat element of the mattress transporter placing the mattress in a folded arrangement; and
securing the first ends of the straps and the second ends of the straps together to secure the mattress in the folded arrangement.

12. The method of claim 11, wherein:
sliding the flat element and straps of the mattress transporter beneath the mattress comprises sliding the flat element and straps of the mattress transporter beneath the mattress such that the first ends of the straps extend beyond a first side of the mattress and the second ends of the straps extend beyond a second side of the mattress; and
pulling the second ends of the straps toward the first ends of the straps folds the mattress along a centerline between the first side and the second side of the mattress.

13. The method of claim 11, wherein:
sliding the flat element and straps of the mattress transporter beneath the mattress comprises sliding the flat element and straps of the mattress transporter beneath the mattress such that the first ends of the straps extend beyond a first end of the mattress and the second ends of the straps extend beyond a second end of the mattress; and
pulling the second ends of the straps toward the first ends of the straps folds the mattress along a centerline between the first end and the second end of the mattress.

14. The method of claim 11, wherein securing the first ends of the straps and the second ends of the straps together includes buckling first ends of the straps to second ends of the straps.

15. The method of claim 11, further comprising:
cinching the straps to further compress the mattress into the folded arrangement.

16. The method of claim 11, further comprising:
grasping the straps;
lifting the mattress in the folded arrangement; and
transporting the mattress while in the folded arrangement.

17. The method of claim 16, wherein grasping the straps comprises grasping handles defined by the straps.

18. The method of claim 17, wherein grasping the handles comprises grasping handles defined by the straps between locations were the straps are sewn to the flat element.

19. A transportable mattress arrangement, comprising:
a mattress with a top surface, a bottom surface, a first end, a second end opposite from the first end, a latitudinal center between the first end and the second end, a first side, a second side opposite from the first side, and a longitudinal center between the first side and the second side; and
a mattress transporter assembled with the mattress and including:
a flat element against the bottom surface of the mattress, the flat element having a length and a width and including a first portion extending from a first end of the length to a center of the length and a second portion extending from a second end of the length to the center of the length, the first portion and the second portion meeting at a center of the length, the flat element having a folded arrangement in which the first portion and the second portion are at least partially superimposed with each other; and
a plurality of straps extending along the length of the flat element, beyond each of the first end and the second end, each strap of the plurality of straps including a first end and a second end secured to each other to place the flat element in the folded arrangement and to fold the mattress, each strap of the plurality of straps secured to the flat element in a manner that defines a series of handles along each of the first portion and the second portion of the flat element.

20. The transportable mattress arrangement of claim 19, wherein the center of the length of the flat element is positioned along the longitudinal center of the mattress.

21. The transportable mattress arrangement of claim 19, wherein the center of the length of the flat element is positioned along the latitudinal center of the mattress.

22. The transportable mattress arrangement of claim 19, wherein the mattress is 150 cm×200 cm (5 feet×6 feet, 6 inches) or larger.
